(19) United States
(12) Patent Application Publication
(10) Pub. No.: US 2025/0001640 A1
(43) Pub. Date: Jan. 2, 2025

(54) HANDHELD CHAINSAW HAVING A CHAIN CATCHER

(71) Applicant: Andreas Stihl AG & Co. KG, Waiblingen (DE)

(72) Inventors: Roland Mandel, Stuttgart (DE); Dominik Scheck, Waiblingen (DE); Daniel Padial, Korb (DE)

(21) Appl. No.: 18/750,712

(22) Filed: Jun. 21, 2024

(30) Foreign Application Priority Data
Jun. 29, 2023 (DE) 10 2023 117 243.3

(51) Int. Cl. B27B 17/02; B27G 19/00

(52) U.S. Cl. CPC B27B 17/02; B27G 19/003

(57) ABSTRACT

A handheld chainsaw includes a cutting assembly, a housing with a lateral contact surface, a sprocket-wheel cover, and a chain catcher with a catch edge. The chainsaw extends in the direction of a longitudinal axis predefined by the cutting assembly. The chain catcher is arranged on the sprocket-wheel cover. The contact surface defines a contact plane. The chain catcher has a free end adjoining the contact surface with no form-fitting position holder acting rearwardly in the direction of the longitudinal axis. At least in the region of its free end, the catch edge of the chain catcher has a catch slope oriented away from the contact surface.

### CROSS-REFERENCE TO RELATED APPLICATIONS

This application claims priority of German patent application no. 10 2023 117 243.3, filed Jun. 29, 2023, the entire content of which is incorporated herein by reference.

### BACKGROUND

In accordance with relevant building regulations, handheld chainsaws have to be provided with suitable protective measures for the event of chain breakage. It is widespread practice to use, for this purpose, a so-called chain catcher, which is arranged on the underside of the respective chainsaw in the vicinity of the drive wheel of the chain. A section of broken chain that may be present, the chain running rearwardly in the direction of the housing on the underside of the guide bar, is intercepted by the chain catcher. The chain catcher has to be configured so as to be capable of absorbing the impact energy from such a chain section. For chainsaw approval, a pendulum-impact test is carried out as a test to simulate chain breakage in order to demonstrate the correct configuration.

Various configurations of such a chain catcher are known in the prior art. In one of these configurations, the chain catcher is fastened directly on the housing. In a variant, the chain catcher also engages, in addition, in a form-fitting manner in a mount of the sprocket-wheel cover. In another configuration, the chain catcher is fastened on the sprocket-wheel cover, but has its free end engaging likewise in a form-fitting manner in a corresponding mount of the housing. In the three cases mentioned, the chain catcher itself is provided with solid support. However, the impact energy from the pendulum hammer or from the chain section striking against the chain catcher is introduced directly into the comparatively rigid housing, which, for want of any flexibility or give, results in high levels of loading there.

In a further known configuration, on which the disclosure here is based, the chain catcher is arranged on the sprocket-wheel cover, wherein it has a free end in contact with a contact surface of the housing, albeit without being secured here by a form-fitting position holder acting in the contact plane. As a result, the active impact energy is introduced in particular into the comparatively flexible sprocket-wheel cover, which damps the active impact by way of corresponding deformation. The housing can be relieved of loading in this way.

In the absence of a form fit with the housing, the deformation occurring as a result of the impact can result in a gap forming between the free end of the chain catcher and the contact surface of the housing, or in an existing gap increasing in size. A suitable configuration ensures that the chain dissipates its energy entirely to the catch edge of the chain catcher, without penetrating in the process into the gap between the chain catcher and contact surface.

### SUMMARY

It is an object of the disclosure to provide a chainsaw in which the chain-catcher configuration therein becomes more robust.

This object is, for example, achieved by a handheld chainsaw having a chain catcher. The handheld chainsaw includes: a cutting assembly; a housing having a lateral contact surface; a sprocket-wheel cover; the chain catcher having a catch edge; the chainsaw extending in the direction of a longitudinal axis predefined by the cutting assembly; the chain catcher being arranged on the sprocket-wheel cover; the lateral contact surface defining a contact plane; the chain catcher having a free end adjoining the lateral contact surface with no form-fitting position holder acting rearwardly in a direction of the longitudinal axis; and, wherein, at least in a region of the free end, the catch edge of the chain catcher has a catch slope oriented away from the lateral contact surface.

According to the disclosure, provision is made for the chain catcher to have a free end adjoining the contact surface with no form-fitting position holder acting rearwardly in the direction of the longitudinal axis, wherein, at least in the region of its free end, the catch edge of the chain catcher has a catch slope oriented away from the contact surface. In particular, the catch slope is configured in the form of a concave catch hook. As a result, the chain is reliably intercepted and retained in the region of the catch edge of the chain catcher. It is possible to introduce relatively high levels of energy, and to realize pronounced deformation of the sprocket-wheel cover for energy-absorption purposes, without the chain being able to penetrate between the sprocket-wheel cover and housing. Doing away with form-fitting attachment to the housing at least in the rearward direction increases the robustness of the chain catcher.

In an embodiment, the catch slope is adjoined, on its side directed away from the contact surface, by a rectilinear catch-edge section located at least more or less perpendicularly on the contact surface. This means that there are no significant force components acting perpendicularly to the contact surface at this location. Undesired lateral deformations and deflections are reduced to a minimum.

In an embodiment, a directing slope is positioned on the contact surface of the housing, and this directing slope at least partially overlaps the catch slope of the chain catcher in the direction of a lateral axis of the chainsaw. In an embodiment, as seen in relation to the longitudinal axis of the chainsaw, the directing slope begins in front of the catch slope of the chain catcher and extends to behind the catch slope of the chain catcher. The directing slope deflects the chain laterally away from the contact surface in good time, prior to impact on the chain catcher, to the extent where there is an increased lateral safety distance from the free end of the chain catcher, and where the effect of the catch slope of the chain catcher is supported.

The chain catcher can be configured in the form of a separate component, but is formed in particular in one piece on the sprocket-wheel cover. In an embodiment, the sprocket-wheel cover is formed from plastic material. It is possible to realize high levels of elastic deformation of the sprocket-wheel cover along with high energy absorption, local stress peaks being avoided in the process, and this contributes to the rest of the structure, in particular in the region of the housing, being relieved of loading.

In an embodiment, away from the chain catcher, the sprocket-wheel cover has a form-fitting position holder acting rearwardly at least in the direction of the longitudinal axis. In particular, the form-fitting position holder is formed by a lug of the sprocket-wheel cover, the lug engaging in a corresponding receiver opening of the housing. On the one hand, the deformation potential of the sprocket-wheel cover is maintained as a result. On the other hand, this ensures precisely positioned attachment of the sprocket-wheel cover and also reliable introduction of forces into the housing.

In an embodiment, at least one positioning aid with no form-fitting position holder for the chain catcher acting rearwardly in the direction of the longitudinal axis is formed on the contact surface of the housing. The positioning aid allows the sprocket-wheel cover to find its position with precision when being mounted, albeit without significantly compromising the elastic deformation and the energy absorption of the sprocket-wheel cover in the event of chain breakage.

### BRIEF DESCRIPTION OF DRAWINGS

The invention will now be described with reference to the drawings wherein:

FIG. 1 shows a perspective view of a chainsaw configured according to the disclosure, having a housing, having a sprocket-wheel cover and having a chain catcher which is loosely in contact with the housing and is provided with a catch slope configured in the form of a catch hook;

FIG. 2 shows a partially schematic view, as seen from beneath, of the chainsaw according to FIG. 1 in the region of its sprocket-wheel cover and of the chain catcher formed in one piece thereon;

FIG. 3 shows an enlarged detail-specific view of a variant of the chainsaw according to FIGS. 1 and 2 with a downwardly acting positioning edge for the chain catcher; and,

FIG. 4 shows an enlarged detail-specific view of a further variant of the chainsaw according to FIGS. 1 and 2 with a directing slope which is formed on the contact surface of the housing and adjoins the chain catcher.

### DETAILED DESCRIPTION

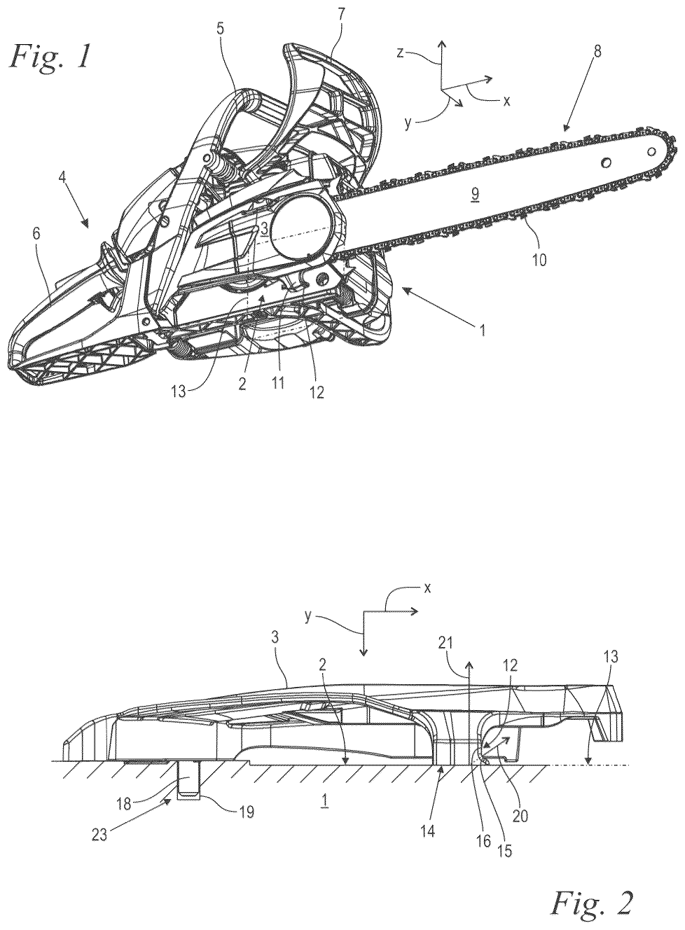

FIG. 1 shows a perspective view, as seen obliquely from the front and beneath, of a handheld chainsaw configured according to the disclosure. The chainsaw includes a housing 1, a handle housing 4 and a cutting assembly 8. In the embodiment shown, the handle housing 4 is isolated from the housing 1 in terms of vibration. As an alternative, the housing 1 and handle housing 4 can also be configured in a rigidly connected manner. A rear handle 6 is formed, and a front bale handle 5 is fastened, on the handle housing 4. During operation, the user holds and guides the chainsaw with one hand on the rear handle 6 and the other hand on the front bale handle 5. A hand protector 7 is located in front of the bale handle 5, as seen in the direction of the cutting assembly 8.

A cutting assembly 8 is mounted laterally on the front of the housing 1, the cutting assembly including a guide bar 9 and a saw chain 10, which can be driven in circulation around the guide bar 9. The saw chain 10 is driven, via a sprocket wheel (not illustrated), by a drive motor (not illustrated either) in the form of a combustion engine. As an alternative, it is also possible to provide a drive motor for the saw chain 10 in the form of a mains-operated or battery-operated electric motor. The aforementioned sprocket wheel and the region where the cutting assembly 8 is fastened on the housing 1 with an associated chain-tensioning device are covered by a sprocket-wheel cover 3, which is fastened laterally on the housing 1.

The guide bar 9 has a flat and overall elongate configuration with a longitudinal direction. The longitudinal direction of the guide bar 9 predefines a longitudinal axis x of the chainsaw. A vertical axis z extends perpendicularly to the longitudinal axis x and parallel to the plane of the flat guide bar 9. A lateral axis y extends perpendicularly to the longitudinal axis z and also perpendicularly to the vertical axis z.

The term “front” here means, as seen in relation to the direction of the longitudinal axis x, the region of the chainsaw having the cutting assembly 8, whereas the term “rear” means, likewise as seen in relation to the direction of the longitudinal axis x, the region of the chainsaw with the handle 6. The term “front” gives rise to the expressions used here to indicate directional and relative information like “in front” along the lines of “oriented toward the front” or “oriented from the handle 6 to the cutting assembly 8”. Analogously, the term “rear” gives rise to the expressions used here to indicate directional and relative information like “behind” and “rearward(ly)” along the lines of “oriented toward the rear” or “oriented from the cutting assembly 8 to the handle 6”.

In the region of its lower edge, as seen in relation to the vertical axis z, the sprocket-wheel cover 3, formed from flexible plastic material, is provided with a chain catcher 11, which is formed on in one piece. It is also possible, however, for the chain catcher 11 to be configured in the form of a separate, for example metal part and to be fastened in a suitable manner on the sprocket-wheel cover 3. In a manner corresponding to the chain catcher 11, the housing 1 has a contact surface 2 for the chain catcher 11. The contact surface 2 defines an imaginary contact plane 13, which is indicated here by a chain-dotted line. The contact plane 13 is located parallel to the longitudinal axis x and also to the vertical axis z.

FIG. 2 shows a partially schematic view, as seen from beneath, of the chainsaw according to FIG. 1 in the region of its sprocket-wheel cover 3. In combination with FIG. 1, it can be seen that the chain catcher 11, which is formed on the sprocket-wheel cover 3, has a free end 14 adjoining the contact surface 2 with no form-fitting position holder acting rearwardly in the direction of the longitudinal axis x, and in particular with none acting in the contact plane 13 as a whole. In other words, the chain catcher rests only loosely on the contact surface 2. Direct contact is not imperative. It can also be sufficient if a narrow gap is present between the free end 14 of the chain catcher 11 and the contact surface 2 of the housing 1.

A form-fitting position holder in particular acting rearwardly in the direction of the longitudinal axis x is intended to mean here a form fit which hinders any change in position of the relevant component, under the action of the broken chain striking against the same, at least in the rearward direction and which, instead, absorbs the corresponding impact energy. The disclosure-envisaged absence of such a form-fitting position holder of the chain catcher 11 on the contact surface 2 therefore means that the chain catcher 11 does not have any direct form-fitting support at least in the rearward direction from the housing 1 or the contact surface 2, and therefore, under the action of the chain striking against it, can spring or yield unhindered at least in the rearward direction and can deform the sprocket-wheel cover 3 in the process. This rules out corresponding energy-absorbing supporting measures acting directly on the chain catcher 11. In particular, it is ruled out that the free end 14 of the chain catcher 11 penetrates for example into a corresponding receiver opening of the contact surface 2.

The chain catcher 11 has formed on it a catch edge 12 for a section of a possibly broken saw chain 10 that strikes against it, the catch edge being oriented, as seen in the direction of the longitudinal axis x, toward the front in the direction of the cutting assembly 8 (FIG. 1). The catch edge 12 has a catch slope 15, which is oriented or inclined away from the contact surface 2. In other words, in the drawing plane defined here by the longitudinal axis x and the lateral axis y, an edge normal direction 20, which is located perpendicularly on the catch slope 15, and a surface normal direction 21, which is located perpendicularly on the contact surface 2, enclose an angle of <90°, so that the edge normal direction 20 is oriented away from the contact surface 2, as seen in the direction of the lateral axis y, and toward the front, as seen in the direction of the longitudinal axis x, that is, is oriented away from the rear handle 6 and in the direction of the cutting assembly 8 (FIG. 1).

The catch slope 15 can extend over the entire length of the catch edge 12 and can thus form the catch edge 12 as a whole. In the embodiment shown, it extends only over the region of the free end 14 of the chain catcher, wherein the catch slope 15 is adjoined, on its side directed away from the contact surface 2, by a rectilinear catch-edge section 16 located at least more or less perpendicularly on the contact surface 2. The catch slope 15 can run rectilinearly or in some other suitable form. In the embodiment shown, it is configured in the form of a concave catch hook with rectilinear and concavely curved edge sections.

It can also be seen in FIG. 2 that, away from the chain catcher 11 and at a distance therefrom, the sprocket-wheel cover 3 has a form-fitting position holder 23 acting rearwardly at least in the direction of the longitudinal axis x, in particular in all directions of the contact plane 13. The form-fitting position holder 23 is located behind the chain catcher 11, as seen in relation to the longitudinal axis x. In the embodiment shown, for this purpose, a lug 18 is formed on the sprocket-wheel cover 3, the lug engaging in a corresponding receiver opening 19 (only indicated schematically here) of the housing 1.

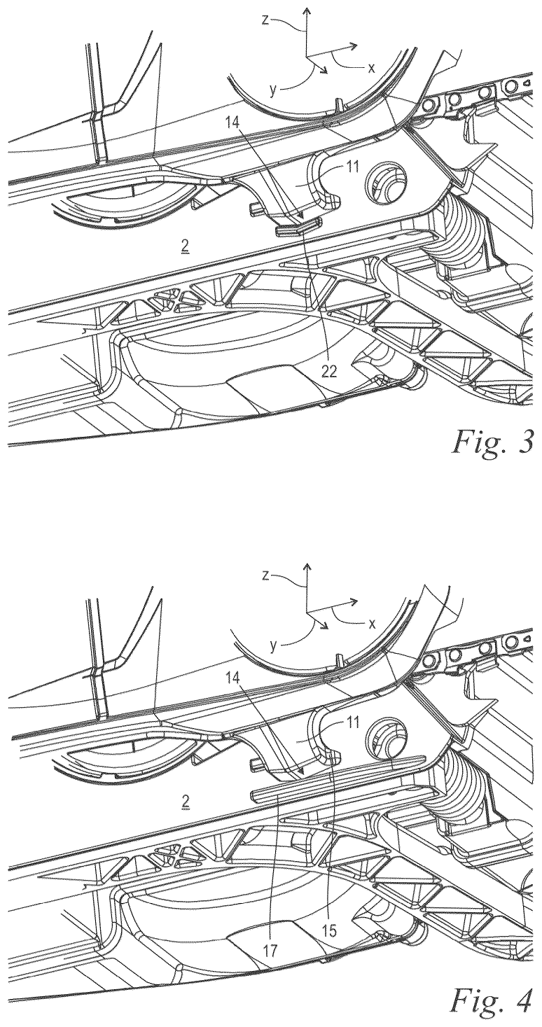

FIG. 3 shows an enlarged detail-specific view of a variant of the chainsaw according to FIGS. 1 and 2. In the case of this embodiment, a positioning edge 22 is formed on the lateral contact surface 2, beneath the free end 14 of the chain catcher 11, the free end being loosely in contact with the positioning edge. This nevertheless does not constitute a form-fitting position holder as is the case with the lug 18 and the receiver opening 19 (FIG. 2). This is because the positioning edge 22 projects beyond the contact surface 2 only to such a small extent that, in the event of simulated or actual chain breakage, the chain catcher 11 can perform a quasi unhindered deformation movement at least in the rearward direction without any significant local introduction of forces into the housing 1.

FIG. 4 shows an enlarged detail-specific view of a further variant of the chainsaw according to FIGS. 1 and 2. In the case of this embodiment, a directing slope 17 is formed on the lateral contact surface 2, beneath the free end 14 of the chain catcher 11, and starting from its front end, as seen in relation to the longitudinal axis x, this directing slope rises above the contact surface 2, the height of the slope increasing in the rearward direction, and then extends beneath the chain catcher 11 to behind at least the catch slope 15 of the latter. In the present case, it even extends to behind the entire chain catcher 11. As seen in the direction of the lateral axis y, the directing slope 17 at least partially overlaps, or projects beyond, the catch slope 15 of the chain catcher 11. This also does not constitute a form-fitting position holder as defined above. Like the positioning edge 22 (FIG. 3), it is also the case that the directing slope projects beyond the contact surface 2 only to such a small extent that, in the event of simulated or actual chain breakage, the chain catcher 11 can perform a quasi unhindered deformation movement at least in the rearward direction without any significant local introduction of forces into the housing 1. As an alternative, the directing slope 17 can also be arranged above the chain catcher 11. It is also possible for the directing slope 17 to be arranged at the same height as the chain catcher 11, in which case the directing slope terminates preferably immediately in front of the chain catcher 11.

As far as the rest of the features and reference signs are concerned, the embodiments according to FIGS. 3 and 4 correspond to one another and with the embodiment according to FIGS. 1 and 2.

It is understood that the foregoing description is that of the preferred embodiments of the invention and that various changes and modifications may be made thereto without departing from the spirit and scope of the invention as defined in the appended claims.

1. A handheld chainsaw comprising:
a cutting assembly;
a housing having a lateral contact surface;
a sprocket-wheel cover;
a chain catcher having a catch edge;
the chainsaw extending in the direction of a longitudinal axis predefined by said cutting assembly;
said chain catcher being arranged on said sprocket-wheel cover;
said lateral contact surface defining a contact plane;
said chain catcher having a free end adjoining said lateral contact surface with no form-fitting position holder acting rearwardly in a direction of the longitudinal axis; and,
wherein, at least in a region of said free end, said catch edge of said chain catcher has a catch slope oriented away from said lateral contact surface.

2. The handheld chainsaw of claim 1, wherein said catch slope is configured in a form of a concave catch hook.

3. The handheld chainsaw of claim 1, wherein said catch slope has a first side directed away from said lateral contact surface; and, said catch slope is adjoined on said first side by a rectilinear catch-edge section disposed perpendicularly on said lateral contact surface.

4. The handheld chainsaw of claim 1, wherein a directing slope is positioned on said lateral contact surface of said housing; and, said directing slope at least partially overlaps said catch slope of said chain catcher in a direction of a lateral axis of the chainsaw.

5. The handheld chainsaw of claim 4, wherein, as seen in relation to the longitudinal axis of the chainsaw, said directing slope begins in front of said catch slope of said chain catcher and extends to behind said catch slope of said chain catcher.

6. The handheld chainsaw of claim 1, wherein said chain catcher is formed in one piece on said sprocket-wheel cover.

7. The handheld chainsaw of claim 1, wherein said sprocket-wheel cover is formed from plastic material.

8. The handheld chainsaw of claim 1, wherein, away from said chain catcher, said sprocket-wheel cover has a form-fitting position holder acting rearwardly at least in the direction of the longitudinal axis.

9. The handheld chainsaw of claim 8, wherein said form-fitting position holder is formed by a lug of said sprocket-wheel cover, said lug engaging in a corresponding receiver opening of said housing.

10. The handheld chainsaw of claim 1, wherein at least one positioning aid with no form-fitting position holder for said chain catcher acting rearwardly in the direction of the longitudinal axis is formed on said lateral contact surface of said housing.
